(19) United States
(12) Patent Application Publication
(10) Pub. No.: US 2014/0010946 A1
(43) Pub. Date: Jan. 9, 2014

(54) METHOD FOR PRODUCING GRANULAR SOY SAUCE AND GRANULAR SOY SAUCE

(71) Applicants: Daisuke Matsui, Chiba (JP); Hiromi Okabe, Chiba (JP); Tomoko Mizutani, Chiba (JP)

(72) Inventors: Daisuke Matsui, Chiba (JP); Hiromi Okabe, Chiba (JP); Tomoko Mizutani, Chiba (JP)

(21) Appl. No.: 14/006,208

(22) PCT Filed: Mar. 16, 2012
(86) PCT No.: PCT/JP2012/056898

§ 371 Date: Sep. 19, 2013

(30) Foreign Application Priority Data
Mar. 22, 2011 (JP) 2011-063378

(51) Int. Cl. A23L 1/238

(52) U.S. Cl. CPC A23L 1/238
USPC 426/650

(57) ABSTRACT

Granular soy sauce is obtained by mixing an edible oil, powdered soy sauce, and at least one porous material selected from the group consisting of pregelatinized rice flour, pregelatinized corn meal, and starch which has been rendered porous by enzyme treatment; and granulating the mixture.

### TECHNICAL FIELD

This invention relates to a method for producing granular soy sauce, and granular soy sauce.

### BACKGROUND ART

So far, powdered soy sauce has been known which is produced by dissolving an excipient, such as dextrin, in soy sauce, and then spraying the soy sauce to dry it (so-called spray drying).

Since powdered soy sauce is hygroscopic, it tends to adsorb water contained in the air. The powdered soy sauce, which has absorbed water, undergoes mutual adhesion of its powder particles, resulting in caking. Since Maillard reaction proceeds, moreover, water arises from the powdered soy sauce, and this water also contributes to caking of the powdered soy sauce.

Powdered soy sauce products prevented from the above caking include the following:

There are powdered soy sauce obtained by swelling starch or the like to form a puff, coating powdery soy sauce with the puff, and further adding a binder thereto (see, for example, Patent Document 1); and a powder formed by mixing a powdery seasoning with a processed powder of milled rice which has been extruded and puffed (see, for example, Patent Document 2).

There are also products using solid oils or fats, including a particulate seasoning prepared by mixing powdered soy sauce and an oil or fat solid at ordinary temperature, granulating the mixture to produce granules A, and mixing low hygroscopicity granules B, such as corn starch, with the granules A (see, for example, Patent Document 3); and a granular food prepared by mixing an oil or fat, which is solid at ordinary temperature, with a foodstuff material such as soup or sauce, and subjecting the mixture to extrusion granulation (see, for example, Patent Document 4). With such particulate seasonings (foods), when powdered soy sauce and solid oils or fats are mixed, the oils or fats are heated to be melted.

There is also available a granular seasoned food prepared by spraying an edible oil onto a reduction roll and, during this process, supplying a foodstuff material to the reduction roll to roll it, followed by granulating the rolled material (see, for example, Patent Document 5).

The particulate soy sauces according to Patent Documents 1 and 2, however, are still insufficient to be prevented from caking. The particulate seasonings (foods) according to Patent Documents 3 and 4 involve heating for melting the solid oils or fats. When the manufacturing processes according to Patent Documents 3 and 4 are applied to soy sauce, the solid oil or fat is mixed with powdered soy sauce, and the mixture is heated. However, the soy sauce has its flavor extremely deteriorated by heating. With the granular seasoned food according to Patent Document 5, moreover, the edible oil is sprayed to avoid deposition of the food material on the reduction roll, and this technique is not sufficient for prevention of caking.

### PRIOR ART DOCUMENTS

### Patent Documents

Patent Document 1: JP-A-63-91058
Patent Document 2: JP-A-63-313574
Patent Document 3: JP-B-49-46072
Patent Document 4: Japanese Patent No. 4,599,154
Patent Document 5: JP-B-4-26820

### SUMMARY OF THE INVENTION

### Problems to be Solved by the Invention

In light of the above-mentioned circumstances, the present invention aims to provide a method for producing granular soy sauce which is capable of preventing caking, and provide granular soy sauce prevented from caking.

### Means for Solving the Problems

A first aspect of the present invention, designed to solve the above-described problems, lies in a method for producing granular soy sauce, comprising: mixing an edible oil, powdered soy sauce, and at least one porous material selected from the group consisting of pregelatinized rice flour, pregelatinized corn meal, and starch which has been rendered porous by enzyme treatment; and granulating the mixture.

According to the first aspect, the porous material and the powdered soy sauce are mixed, whereby the powdered soy sauce is carried by the porous material. Thus, mutual contact of the powdered soy sauce is suppressed, so that granular soy sauce prevented from caking can be produced. Since the powdered soy sauce carried by the porous material is covered with the edible oil, moreover, contact between the powdered soy sauce and water can be suppressed. Consequently, moisture absorption of the powdered soy sauce carried by the porous material can be prevented, and granular soy sauce prevented from caking associated with the moisture absorption can be produced. With the method for production of granular soy sauce according to the present invention, moreover, the liquid edible oil is used without the use of a solid oil or fat. That is, heating for melting the solid oil or fat is not performed. Thus, it becomes possible to produce granular soy sauce in which the flavor characteristic of soy sauce is not impaired.

A second aspect of the present invention consists in the method for producing granular soy sauce according to the first aspect, wherein the edible oil is rice bran oil, or an oil or fat which consists essentially of a triacylglycerol formed by the ester linkage of a fatty acid having 6 to 10 carbon atoms and glycerol.

According to the above second aspect, granular soy sauce prevented from caking more reliably is provided.

A third aspect of the present invention consists in the method for producing granular soy sauce according to the first or second aspect, wherein the granulating is performed by extrusion granulation.

According to the above third aspect, granular soy sauce prevented from caking more reliably is provided.

A fourth aspect of the present invention consists in granular soy sauce, comprising: an edible oil; powdered soy sauce; and at least one porous material selected from the group consisting of pregelatinized rice flour, pregelatinized corn meal, and starch which has been rendered porous by enzyme treatment.

According to the above fourth aspect, the powdered soy sauce is carried by the porous material. Thus, mutual contact of the powdered soy sauce is suppressed, so that the granules of granular soy sauce are prevented from sticking to each other and caking. Since the powdered soy sauce carried by the porous material is covered with the edible oil, moreover, contact between the powdered soy sauce and water can be suppressed. Consequently, moisture absorption of the powdered soy sauce carried by the porous material can be prevented, and the granules of the granular soy sauce are prevented from sticking to each other and caking as a result of the moisture absorption. With the granular soy sauce according to the present invention, moreover, the liquid edible oil is used without the use of a solid oil or fat. Since heating for melting the solid oil or fat is not performed, therefore, the flavor characteristic of soy sauce is not impaired.

### Effects of the Invention

According to the present invention, there are provided a method for producing granular soy sauce capable of preventing caking, and granular soy sauce preventing from caking.

### BRIEF DESCRIPTION OF THE DRAWINGS

FIG. 1 shows the mesh passage rates according to Examples and Comparative Examples in Test Example 1.

FIG. 2 shows the mesh passage rates according to Comparative Examples in Test Example 2.

FIG. 3 shows the mesh passage rates according to Example and Comparative Examples in Test Example 3.

FIG. 4 shows the mesh passage rates according to Examples and Comparative Examples in Test Example 4.

FIG. 5 shows the mesh passage rates according to Examples and Comparative Example in Test Example 5.

### MODE FOR CARRYING OUT THE INVENTION

The granular soy sauce according to the present invention uses powdered soy sauce, a porous material, and an edible oil as starting materials.

The powdered soy sauce for use in the present invention is a powdery form of soy sauce, so-called powdered soy sauce, which is obtained by spray drying or freeze drying ordinary soy sauce as such; or by mixing with or dissolving in soy sauce an excipient such as starch, dextrin, gelatin or gum arabic, and if desired, sodium chloride, an amino acid-based seasoning such as monosodium glutamate, a nucleotide seasoning such as sodium-5′-inosinate or sodium guanylate, or an alcoholic beverage or spice such as “mirin” (sweet sake for seasoning), sake or wine, and spray drying or freeze drying the mixture or solution. The soy sauce used in this case is not limited in the present invention and, depending on uses, may be any soy sauce, such as dark-colored soy sauce; light-colored soy sauce; very pale-colored soy sauce; thick soy sauce; or enriched soy sauce prepared using unpasteurized soy sauce instead of sodium chloride solution; a low salt type of each of these soy sauces; or a very low salt type of each of these soy sauces.

The porous material for use in the present invention is at least one porous material selected from the group consisting of pregelatinized rice flour, pregelatinized corn meal, and starch which has been rendered porous by enzyme treatment.

The pregelatinized rice flour is obtained by pregelatinizing milled rice, immature rice, brown rice, crushed milled rice, or white rice bran; and then crushing the pregelatinized material. Examples of the pregelatinizing method are a method which comprises heating each of the above-mentioned various rice products by steaming, broiling, roasting or the like, for modification; and a method which involves puffing.

The pregelatinized corn meal is obtained by powdering dried corn, and pregelatinizing the powder. The method of pregelatinization can be performed by the same method as for the pregelatinized rice flour. The type of corn is not limited.

The starch which has been rendered porous by enzyme treatment undergoes the action of an enzyme on the particles of starch such as that of corn, whereby countless minute pores are formed in the surfaces of the particles. Such starch has particulate or spherical shapes.

The edible oil used in the present invention is an oil or fat which is liquid under ordinary temperature conditions (for example, about 20° C. to 25° C.) Preferably, it is an oil or fat which consists essentially of a triacylglycerol (may be called triglyceride) formed by the ester linkage of a fatty acid having 6 to 10 carbon atoms (medium chain fatty acid) and glycerol. Examples of the edible oil containing the triacylglycerol are rice bran oil and palm oil. Rice bran oil is a generic name for oils and fats derived from rice, especially, oils and fats extracted from rice bran and/or rice germ.

The granular soy sauce of the present invention is a granular product containing the edible oil, the powdered soy sauce, and the porous material which is at least one material selected from the group consisting of the pregelatinized rice flour, the pregelatinized corn meal, and the starch which has been rendered porous by enzyme treatment.

The porous material contained in the above-described granular soy sauce has numerous pores, and the powdered soy sauce is carried by these pores. Since the powdered soy sauce is carried by the pores, the powdered soy sauce carried by one porous part of the granular soy sauce is inhibited from directly contacting the powdered soy sauce carried by another porous part of the granular soy sauce.

Furthermore, the edible oil contained in the granular soy sauce covers the surfaces of the powdered soy sauce carried by the porous material. Thus, water in the air is kept out of contact with the powdered soy sauce carried by the porous material.

With the granular soy sauce of the present invention as described above, the powdered soy sauce is carried by the porous material, whereby mutual contact of the powdered soy sauce is suppressed. Hence, the granules of the granular soy sauce are prevented from sticking together and caking. Since the powdered soy sauce carried by the porous material is covered with the edible oil, moreover, contact between the powdered soy sauce and water can be suppressed. Consequently, moisture absorption by the powdered soy sauce carried by the porous material can be prevented, and the sticking and caking of the granules of the granular soy sauce associated with the moisture absorption can be prevented.

With the granular soy sauce of the present invention, moreover, no solid oil or fat is used, but the edible oil which is a liquid oil or fat is used. That is, heating for melting a solid oil or fat is not performed. Thus, the flavor characteristic of soy sauce is not impaired.

The method for producing the granular soy sauce of the present invention will be described hereinbelow.

First, an edible oil, powdered soy sauce, and at least one porous material selected from the group consisting of pregelatinized rice flour, pregelatinized corn meal, and starch which has been rendered porous by enzyme treatment are mixed together.

For example, the powdered soy sauce and the porous material are placed in a container, and stirred until the system becomes uniform. Then, the edible oil is placed in the container, and the materials are further stirred to attain uniformity, thereby mixing the porous material, the edible oil and the powdered soy sauce. Needless to say, the method of mixing is not limited to such a sequence. The powdered soy sauce, the porous material, and the edible oil may be charged into the container in any sequence, and stirred each time they are charged, whereby they may be mixed. Alternatively, the powdered soy sauce, the porous material, and the edible oil may be charged into the container at the same time, and stirred, whereby they may be mixed.

By so mixing the powdered soy sauce, the porous material, and the edible oil, the powdered soy sauce is carried by the porous material, and the powdered soy sauce is covered with the edible oil. Moreover, the entire mixture having the powdered soy sauce, the porous material, and the edible oil mixed together is brought into a wet state by the action of the edible oil.

Then, the mixture obtained by mixing the powdered soy sauce, the porous material, and the edible oil is granulated. The granulation in the present invention refers to shaping of this mixture into a particulate or granular form.

As the above granulation, there can be employed a publicly known granulation method, such as an extrusion granulation method, a fluidized bed granulation method, a compression granulation method, or a crushing granulation method. Particularly, it is preferred to perform granulation with the use of an extrusion granulator. For example, an extrusion granulator having a screen with openings measuring 0.8 mm to 2.0 mm is used, and the mixture is extruded through this screen to granulate the mixture. There are no limitations on the shape and size of each granule of the granular soy sauce. It is recommendable to adjust the openings of the screen such that the granular soy sauce of the desired shapes and sizes is obtained.

By performing the above-mentioned granulation, the granular soy sauce according to the present invention is obtained from a pasty mixture obtained by mixing the powdered soy sauce, the porous material, and the edible oil. That is, the granular soy sauce having the powdered soy sauce carried by the porous material and covered with the edible oil is obtained.

According to the method for producing granular soy sauce concerned with the present invention described above, the porous material and the powdered soy sauce are mixed, whereby the powdered soy sauce is carried by the porous material. As a result, mutual contact of the powdered soy sauce is suppressed, so that granular soy sauce prevented from caking can be produced. Since the powdered soy sauce carried by the porous material is covered with the edible oil, moreover, contact between the powdered soy sauce and water can be suppressed. Consequently, moisture absorption of the powdered soy sauce carried by the porous material can be prevented, and granular soy sauce prevented from caking associated with the moisture absorption can be produced.

With the method for producing granular soy sauce according to the present invention, it is preferred that the weight ratio between the powdered soy sauce and the porous material (powdered soy sauce:porous material) be 30:70 to 95:5(%). It is also preferred that the amount of the edible oil be 1 to 10% by weight (outer percentage) with respect to the weight of the mixture of the powdered soy sauce and the porous material. By mixing the powdered soy sauce, the porous material and the edible oil at such a ratio, granular soy sauce prevented from caking more reliably can be produced.

With the method for producing granular soy sauce according to the present invention, moreover, the liquid edible oil is used without the use of a solid oil or fat. That is, heating for melting the solid oil or fat is not performed. Thus, it becomes possible to produce granular soy sauce in which the flavor characteristic of soy sauce is not impaired.

### EXAMPLES

The present invention will be described more specifically by showing Examples.

### Example 1-A1

80 Grams of powdered soy sauce according to the present invention (produced by KIKKOMAN CORP.; powdered soy sauce used in all of Examples and Comparative Examples to be presented later is the product of KIKKOMAN CORP.), 20 g of puffed (pregelatinized) rice flour according to the present invention (will hereinafter be referred to as puffed rice flour), and 5 cc of an edible oil according to the present invention were used. The puffed rice flour used was Puffgen (registered trademark) produced by KIKKOMAN CORP. The edible oil used was PANACET (registered trademark) produced by NOF CORPORATION. PANACET (registered trademark) is an example of an oil or fat consisting essentially of a triacylglycerol (TAG) formed by the ester linkage of a fatty acid having 6 to 10 carbon atoms and glycerol. This product will hereinafter be called a TAG-containing oil or fat.

Of the total weight of the powdered soy sauce and the puffed rice flour, 80% was accounted for by the powdered soy sauce, and 20% was occupied by the puffed rice flour. The TAG-containing oil or fat constituted 5% (5 cc; outer percentage) of the total weight of the powdered soy sauce and the puffed rice flour.

The powdered soy sauce and the puffed rice flour were placed in a container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by an extrusion granulator (produced by TSUTSUI SCIENTIFIC INSTRUMENTS CO., LTD. (product name: KAR-75), using a mesh having openings measuring 1.19 mm square (14 mesh); the same will apply hereinafter). The granules were further dried to obtain granular soy sauce (Example 1-A1).

### Example 1-A2

The weight of the TAG-containing oil or fat was set at 10% (outer percentage) with respect to the total weight of the powdered soy sauce and the puffed rice flour. Concretely, its weight percentage was set at 10 cc. The weights of the powdered soy sauce and the puffed rice flour were the same as those in Example 1-A1. Powdered soy sauce (Example 1-A2) was obtained in the same manner as in Example 1-A1.

### Comparative Example 1-A0

The weights of the powdered soy sauce and the puffed rice flour were the same as those in Example 1-A1, but no edible oil was used.

The powdered soy sauce and the puffed rice flour were placed in the container, and mixed with stirring to obtain a mixture. To the mixture, 40 ml of ethanol-water (concentration 90%) was added, and then the mixture was granulated by the extrusion granulator to obtain granular soy sauce (Comparative Example 1-A0).

### Example 1-B1

80 Grams of the powdered soy sauce according to the present invention, 20 g of starch rendered porous by enzyme treatment according to the present invention (will hereinafter be referred to as porosity-imparted starch), and the TAG-containing oil or fat according to the present invention were used. The porosity-imparted starch used was Ronfudo OWP (registered trademark) produced by NIPPON STARCH CHEMICAL CO., LTD. The TAG-containing oil or fat used was the same as in Example 1-A1. Of the total weight of the powdered soy sauce and the porosity-imparted starch, 80% was accounted for by the powdered soy sauce, and 20% was occupied by the porosity-imparted starch. The TAG-containing oil or fat constituted 5% (5 cc; outer percentage) of the total weight of the powdered soy sauce and the porosity-imparted starch.

The powdered soy sauce and the porosity-imparted starch were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Example 1-B1).

### Example 1-B2

The TAG-containing oil or fat used was the same as in Example 1-B1. The weight of the TAG-containing oil or fat was set at 10% (outer percentage) with respect to the total weight of the powdered soy sauce and the porosity-imparted starch. Concretely, its weight percentage was set at 10 cc. The weights of the powdered soy sauce and the porosity-imparted starch were the same as those in Example 1-B1. Powdered soy sauce (Example 1-B2) was obtained in the same manner as in Example 1-B1.

### Comparative Example 1-B0

The weights of the powdered soy sauce and the porosity-imparted starch were the same as those in Example 1-B1, but no edible oil was used.

The powdered soy sauce and the porosity-imparted starch were placed in the container, and mixed with stirring to obtain a mixture. To the mixture, 40 ml of ethanol-water (concentration 90%) was added, and then the mixture was granulated by the extrusion granulator to obtain granular soy sauce (Comparative Example 1-B0).

### Example 1-C1

80 Grams of the powdered soy sauce according to the present invention, 20 g of puffed (pregelatinized) corn flour (produced by KIKKOMAN CORP.) as an example of the pregelatinized (puffed) corn meal according to the present invention, and the TAG-containing oil or fat according to the present invention were used. The TAG-containing oil or fat used was the same as in Example 1-A1. Of the total weight of the powdered soy sauce and the puffed corn flour, 80% was accounted for by the powdered soy sauce, and 20% was occupied by the puffed corn flour. The TAG-containing oil or fat constituted 5% (5 cc; outer percentage) of the total weight of the powdered soy sauce and the puffed corn flour.

The powdered soy sauce and the puffed corn flour were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Example 1-C1).

### Example 1-C2

The TAG-containing oil or fat used was the same as in Example 1-B1. The weight of the TAG-containing oil or fat was set at 10% (outer percentage) with respect to the total weight of the powdered soy sauce and the puffed corn flour. Concretely, its weight percentage was set at 10 cc. The weights of the powdered soy sauce and the puffed corn flour were the same as those in Example 1-C1. Powdered soy sauce (Example 1-C2) was obtained in the same manner as in Example 1-C1.

### Comparative Example 1-C0

The weights of the powdered soy sauce and the puffed corn flour were the same as those in Example 1-C1, but no edible oil was used.

The powdered soy sauce and the puffed corn flour were placed in the container, and mixed with stirring to obtain a mixture. To the mixture, 40 ml of ethanol-water (concentration 90%) was added, and then the mixture was granulated by the extrusion granulator to obtain granular soy sauce (Comparative Example 1-C0).

### Test Example 1

Each of the granular soy sauces according to the Examples and the Comparative Examples described above was caused to absorb moisture under predetermined conditions. Then, the weight of the granular soy sauce, which passed through a mesh having openings measuring 1.19 mm (14 mesh) square, was measured. The mesh passage rate, which is the proportion of the weight (Y) of the granular soy sauce having passed through the mesh to the weight (X) of the granular soy sauce placed on the mesh, was calculated ((Y/X)×100(%)).

Concretely, each of the granular soy sauces according to the Examples and the Comparative Examples was placed in a container in an environment at a temperature of 30° C. and a relative humidity of 52%, and the container was closed. This container was allowed to stand for 15 hours under the same environment. Then, the weight (Y) of the granular soy sauce was measured.

An impact was applied to the container by means of a tapping device (produced by HOSOKAWA MICRON CORP.; product name: POWDER TESTER), and this procedure was repeated 20 times. The tapping device is a device capable of repeating the act of dropping the container accommodating the granular soy sauce from a height of the order of 2 cm onto a pedestal.

After application of the impact by the tapping device, the granular soy sauce in the container was supplied to the mesh. The weight (X) of the granular soy sauce having passed through the mesh was measured, and the mesh passage rate was calculated.

The openings of the mesh each measured 1.19 mm (14 mesh). The average particle size of each of the granular soy sauces according to the Examples and the Comparative Examples was 1 mm. The granular soy sauce is a product which passed through the 14 mesh (opening size: 1.19 mm) after extrusion granulation through the 1 mm screen, followed by drying.

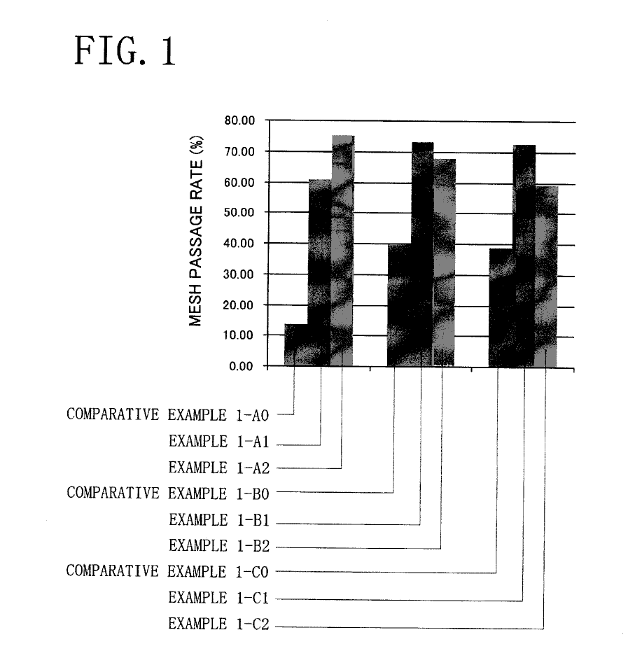

FIG. 1 shows the mesh passage rates according to the Examples and the Comparative Examples. As shown in the drawing, the mesh passage rates were about 60% in Example 1-A1, about 75% in Example 1-A2, about 73% in Example 1-B1, about 68% in Example 1-B2, about 72% in Example 1-C1, and about 58% in Example 1-C2. The mesh passage rates were about 13% in Comparative Example 1-A0, about 40% in Comparative Example 1-B0, and about 37% in Comparative Example 1-C0.

Empirically, it is preferred that the mesh passage rate be more than 50% in order for the granular soy sauce to be prevented from caking. The mesh passage rates exceeded 50% in all of Examples 1-A1, 1-A2, 1-B1, 1-B2, 1-C1 and 1-C2 incorporating the edible oil (TAG-containing oil or fat), but were less than 50% in all of Comparative Examples 1-A0, 1-B0 and 1-C0 free from the edible oil.

That is, the granular soy sauce prevented from caking was obtained by mixing the powdered soy sauce, the porous material and the edible oil.

### Comparative Example 2-A

80 Grams of the powdered soy sauce according to the present invention, 20 g of commercially available pregelatinized tapioca as an example of starch capable of carrying the powdered soy sauce, and 5 cc of the TAG-containing oil or fat according to the present invention were used.

Of the total weight of the powdered soy sauce and the pregelatinized tapioca, 80% was accounted for by the powdered soy sauce, and 20% was occupied by the pregelatinized tapioca. The TAG-containing oil or fat constituted 5% (5 cc; outer percentage) of the total weight of the powdered soy sauce and the pregelatinized tapioca.

The powdered soy sauce and the pregelatinized tapioca were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Comparative Example 2-A).

### Comparative Example 2-B

80 Grams of the powdered soy sauce according to the present invention, 20 g of non-pregelatinized potato starch (Matsutani Chemical Industry Co., Ltd.) as an example of starch capable of carrying the powdered soy sauce, and 5 cc of the TAG-containing oil or fat according to the present invention were used.

Of the total weight of the powdered soy sauce and the non-pregelatinized potato starch, 80% was accounted for by the powdered soy sauce, and 20% was occupied by the non-pregelatinized potato starch. The TAG-containing oil or fat constituted 5% (5 cc; outer percentage) of the total weight of the powdered soy sauce and the non-pregelatinized potato starch.

The powdered soy sauce and the non-pregelatinized potato starch were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Comparative Example 2-B).

### Comparative Example 2-C

80 Grams of the powdered soy sauce according to the present invention, 20 g of commercially available lactose capable of carrying the powdered soy sauce, and 5 cc of the TAG-containing oil or fat according to the present invention were used.

Of the total weight of the powdered soy sauce and the lactose, 80% was accounted for by the powdered soy sauce, and 20% was occupied by the lactose. The TAG-containing oil or fat constituted 5% (5 cc; outer percentage) of the total weight of the powdered soy sauce and the lactose.

The powdered soy sauce and the lactose were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Comparative Example 2-C).

### Comparative Example 2-D

80 Grams of the powdered soy sauce according to the present invention, 20 g of commercially available non-pregelatinized nonglutinous rice flour capable of carrying the powdered soy sauce, and 5 cc of the TAG-containing oil or fat according to the present invention were used. The non-pregelatinized nonglutinous rice flour is obtained by milling nonglutinous rice.

Of the total weight of the powdered soy sauce and the non-pregelatinized nonglutinous rice flour, 80% was accounted for by the powdered soy sauce, and 20% was occupied by the non-pregelatinized nonglutinous rice flour. The TAG-containing oil or fat constituted 5% (5 cc; outer percentage) of the total weight of the powdered soy sauce and the non-pregelatinized nonglutinous rice flour.

The powdered soy sauce and the non-pregelatinized nonglutinous rice flour were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Comparative Example 2-D).

### Comparative Example 2-E

80 Grams of the powdered soy sauce according to the present invention, 20 g of commercially available non-pregelatinized rice flour capable of carrying the powdered soy sauce, and 5 cc of the TAG-containing oil or fat according to the present invention were used.

Of the total weight of the powdered soy sauce and the rice flour, 80% was accounted for by the powdered soy sauce, and 20% was occupied by the rice flour. The TAG-containing oil or fat constituted 5% (5 cc; outer percentage) of the total weight of the powdered soy sauce and the rice flour.

The powdered soy sauce and the rice flour were placed in the container, and mixed with stirring. Further, the TAG-containing oil or fat was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Comparative Example 2-E).

### Test Example 2

In connection with the granular soy sauces according to the above-described Comparative Examples, the mesh passage rate was calculated in the same manner as in Test Example 1. The opening size of the mesh was 1.19 mm (14 mesh). The average particle size of each of the granular soy sauces according to the Comparative Examples in the present Test Example was 1 mm.

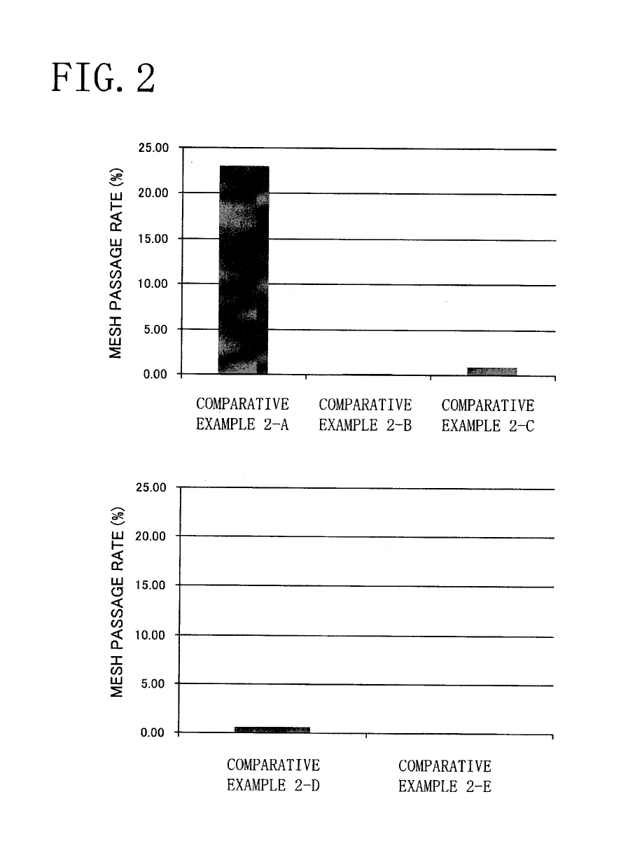

FIG. 2 shows the mesh passage rates according to the Comparative Examples. As shown in the drawing, the mesh passage rates were about 23% in Comparative Example 2-A, about 0.09% in Comparative Example 2-B, about 1% in Comparative Example 2-C, about 0.59% in Comparative Example 2-D, and about 0.09% in Comparative Example 2-E. The mesh passage rates were less than 50% in all of the above Comparative Examples.

The differences between these Comparative Examples and the Examples concerned with Test Example 1 resided in the porous materials. The mesh passage rates were more than 50% in the Examples related to Test Example 1 which used pregelatinized rice flour, starch rendered porous by enzyme treatment, and pregelatinized corn meal as the porous materials. By contrast, the mesh passage rates were less than 50% in the Comparative Examples in the present Test Example which used porous materials other than these.

That is, the granular soy sauce prevented from caking was obtained by using the porous material according to the present invention.

### Example 3-A

80 Grams of the powdered soy sauce according to the present invention, 20 g of the puffed rice flour according to the present invention, and 5 cc of rice bran oil as the edible oil according to the present invention were used.

Of the total weight of the powdered soy sauce and the puffed rice flour, 80% was accounted for by the powdered soy sauce, and 20% was occupied by the puffed rice flour. The rice bran oil constituted 5% (5 cc; outer percentage) of the total weight of the powdered soy sauce and the puffed rice flour.

The powdered soy sauce and the puffed rice flour were placed in the container, and mixed with stirring. Further, the rice bran oil was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce (Example 3-A).

### Comparative Example 3-B

The weights of the powdered soy sauce and the puffed rice flour were the same as those in Example 3-A. As an oil served for eating and liquid at ordinary temperatures, 5 cc of commercially available corn oil was used. Powdered soy sauce (Comparative Example 3-B) was obtained in the same manner as in Example 3-A.

### Comparative Example 3-C

The weights of the powdered soy sauce and the puffed rice flour were the same as those in Example 3-A. As an oil served for eating and liquid at ordinary temperatures, 5 cc of commercially available rapeseed oil was used. Powdered soy sauce (Comparative Example 3-C) was obtained in the same manner as in Example 3-A.

### Comparative Example 3-D

The weights of the powdered soy sauce and the puffed rice flour were the same as those in Example 3-A. As an oil served for eating and liquid at ordinary temperatures, 5 cc of commercially available olive oil was used. Powdered soy sauce (Comparative Example 3-D) was obtained in the same manner as in Example 3-A.

### Comparative Example 3-E

The weights of the powdered soy sauce and the puffed rice flour were the same as those in Example 3-A. As an oil served for eating and liquid at ordinary temperatures, 5 cc of commercially available sesame oil was used. Powdered soy sauce (Comparative Example 3-E) was obtained in the same manner as in Example 3-A.

### Comparative Example 3-F

The weights of the powdered soy sauce and the puffed rice flour were the same as those in Example 3-A. As an oil served for eating and solid at ordinary temperatures, 5 cc of commercially available lard was used. The powdered soy sauce and the puffed rice flour were placed in the container, and mixed with stirring. Further, the lard was placed in the container, and heated to such a temperature as to melt the lard. The molten lard was mixed with the above materials with stirring to obtain a mixture. To the mixture, 40 ml of ethanol-water (concentration 90%) was added, and then the mixture was granulated by the extrusion granulator. The granules were further dried to obtain granular soy sauce (Example 3-F).

### Test Example 3

In connection with the granular soy sauces according to the above-described Example and Comparative Examples, the mesh passage rate was calculated in the same manner as in Test Example 1. The opening size of the mesh was 1.19 mm (14 mesh). The average particle size of each of the granular soy sauces according to the Example and the Comparative Examples in the present Test Example was 1 mm.

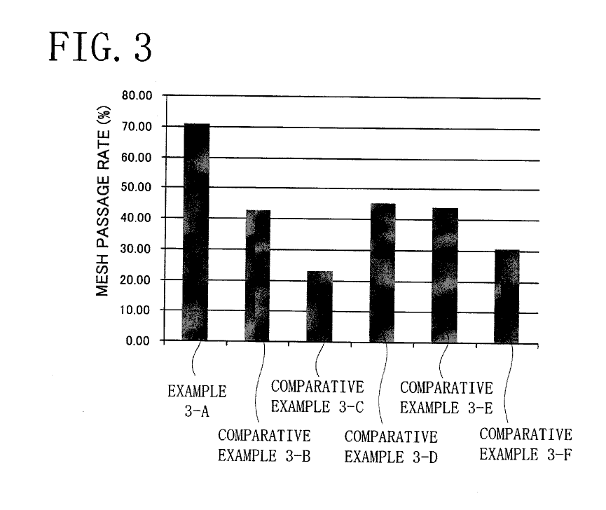

FIG. 3 shows the mesh passage rates according to the Example and the Comparative Examples. As shown in the drawing, the mesh passage rates were 70.94% in Example 3-A, 42.64% in Comparative Example 3-B, 23.04% in Comparative Example 3-C, 45.35% in Comparative Example 3-D, 43.83% in Comparative Example 3-E, and 30.57% in Comparative Example 3-F. The mesh passage rate in Example 3-A exceeded 50%, while the mesh passage rates were less than 50% in all of Comparative Examples 3-B to 3-F.

The differences among the above Example, the above Comparative Examples and the Examples using the TAG-containing oil or fat concerned with Test Example 1 resided in the edible oils used. The mesh passage rates were more than 50% in Examples 1-A1, 1-A2, 1-B1, 1-B2, 1-C1 and 1-C2 in Test Example 1 which used the TAG-containing oil or fat as the edible oil, and Example 3-A in the present Test Example using rice bran oil as the edible oil. By contrast, the mesh passage rates were less than 50% in Comparative Examples 3-B to 3-F in the present Test Example which used oils other than those oils.

That is, the granular soy sauce prevented from caking was obtained by using the edible oil according to the present invention. In Comparative Example 3-F, the solid oil was used, and thus heated during production. Because of this heating, the granular soy sauce according to Comparative Example 3-F declined in flavor.

### Examples 4-B to 4-G, Comparative Examples 4-A, 4-H, 4-I

The proportions of the powdered soy sauce according to the present invention, the puffed rice flour according to the present invention, and the TAG-containing oil or fat according to the present invention, which were used in each of the Examples and the Comparative Examples, are shown in Table 1.

TABLE 1

| | Comp. Ex. | Ex. | Ex. | Ex. | Ex. | Ex. | Ex. | Comp. Ex. | Comp. Ex. |
|---|---|---|---|---|---|---|---|---|---|
| | 4-A | 4-B | 4-C | 4-D | 4-E | 4-F | 4-G | 4-H | 4-I |
| Proportion | 0 | 30 | 50 | 80 | 85 | 90 | 95 | 96 | 100 |
| of powdered | | | | | | | | | |
| soy sauce | | | | | | | | | |
| (%) | | | | | | | | | |
| Proportion | 100 | 70 | 50 | 20 | 15 | 10 | 5 | 4 | 0 |
| of puffed | | | | | | | | | |
| rice flour | | | | | | | | | |
| (%) | | | | | | | | | |
| Proportion | 5 | 5 | 5 | 5 | 5 | 5 | 5 | 5 | 5 |
| of TAG- | | | | | | | | | |
| containing | | | | | | | | | |
| oil or fat | | | | | | | | | |
| (%; outer | | | | | | | | | |
| percentage) | | | | | | | | | |

The powdered soy sauce and the puffed rice flour in the proportions shown in Table 1 were placed in the container, and mixed with stirring. Further, the TAG-containing oil or fat in the proportion of 5% (outer percentage) with respect to the total weight of the powdered soy sauce and the puffed rice flour was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce of each of the Examples and the Comparative Examples.

### Test Example 4

In connection with the granular soy sauces according to the above-described Examples and Comparative Examples, the mesh passage rate was calculated in the same manner as in Test Example 1. The opening size of the mesh was 1.19 mm (14 mesh). The average particle size of each of the granular soy sauces according to the Examples and the Comparative Examples in the present Test Example was 1 mm.

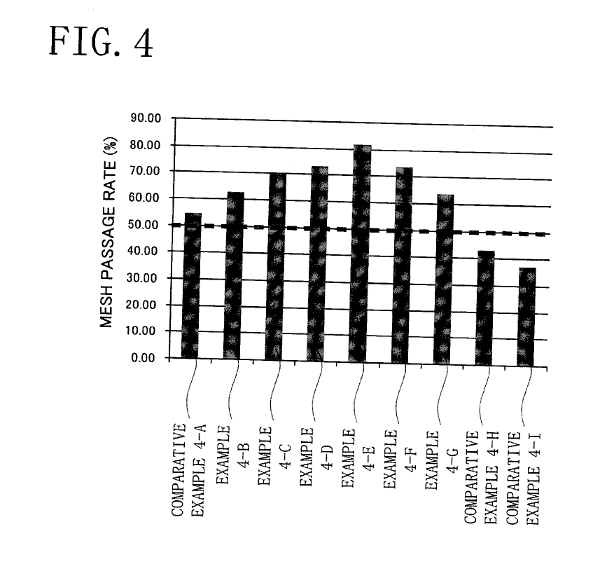

FIG. 4 shows the mesh passage rates according to the Examples and the Comparative Examples. As shown in the drawing, the mesh passage rates were 54.27% in Comparative Example 4-A, 62.61% in Example 4-B, 69.64% in Example 4-C, 73.20% in Example 4-D, 81.66% in Example 4-E, 73.57% in Example 4-F, 63.82% in Example 4-G, 43.14% in Comparative Example 4-H, and 37.03% in Comparative Example 4-I. The mesh passage rates in Examples 4-B to 4-G exceeded 50%, while the mesh passage rates were less than 50% in both of Comparative Examples 4-H and 4-I.

The above results show that the preferred proportions of the powdered soy sauce and the puffed rice flour were 30:70 to 95:5.

### Examples 5-B to 5-E, Comparative Example 5-A

The proportions of the powdered soy sauce according to the present invention, the puffed rice flour according to the present invention, and the TAG-containing oil or fat according to the present invention, which are used in each of the Examples and the Comparative Example, are shown in Table 2.

TABLE 2

| | Comp. Ex. | Ex. | Ex. | Ex. | Ex. |
|---|---|---|---|---|---|
| | 5-A | 5-B | 5-C | 5-D | 5-E |
| Proportion of powdered soy | 80 | 80 | 80 | 80 | 80 |
| sauce (%) | | | | | |
| Proportion of puffed rice | 20 | 20 | 20 | 20 | 20 |
| flour (%) | | | | | |
| Proportion of TAG-containing | 0 | 1 | 5 | 15 | 20 |
| oil or fat (%; outer percentage) | | | | | |

The powdered soy sauce and the puffed rice flour in the proportions shown in Table 2 were placed in the container, and mixed with stirring. Further, the TAG-containing oil or fat in the proportion (outer percentage) shown in Table 2 with respect to the total weight of the powdered soy sauce and the puffed rice flour was placed in the container, and mixed with these materials with stirring to obtain a mixture. To the mixture, 40 ml of ethanol-water (concentration 90%) was added, and then the mixture was granulated by the extrusion granulator. The granules were further dried to obtain granular soy sauce of each of the Comparative Example and the Examples.

### Test Example 5

In connection with the granular soy sauces according to the above-described Examples and Comparative Example, the mesh passage rate was calculated in the same manner as in Test Example 1. The opening size of the mesh was 1.19 mm (14 mesh). The average particle size of each of the granular soy sauces according to the Examples and the Comparative Example in the present Test Example was 1 mm.

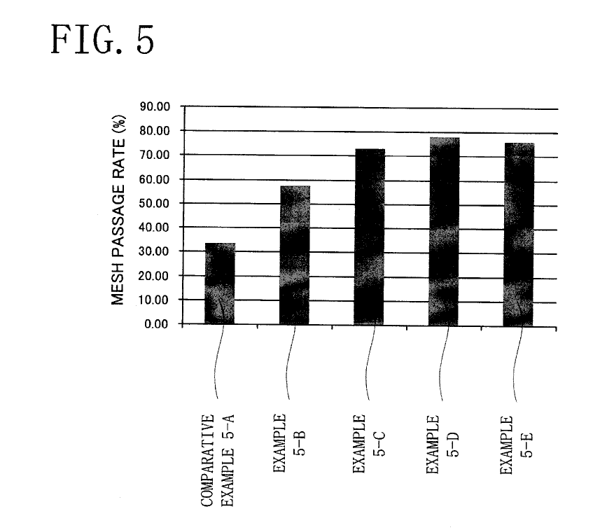

FIG. 5 shows the mesh passage rates according to the Examples and the Comparative Example. As shown in the drawing, the mesh passage rates were 33.42% in Comparative Example 5-A, 57.31% in Example 5-B, 73.20% in Example 5-C, 78.01% in Example 5-D, and 75.92% in Example 5-E. The mesh passage rates in Examples 5-B to 5-E exceeded 50%, while the mesh passage rate was less than 50% in Comparative Example 5-A.

The above results show that the preferred proportion of the TAG-containing oil or fat was 1 to 20% (outer percentage) with respect to the powdered soy sauce and the puffed rice flour. If the proportion of the TAG-containing oil or fat exceeded 20% (outer percentage), the amount of the oil was so large that granulation was difficult.

### Comparative Example 6-A

Powdered soy sauce, puffed rice flour, and TAG-containing oil or fat for use in Comparative Example 6-A are the same as those in Example 1-A1. The powdered soy sauce and Puffgen (registered trademark) were placed in the container, and mixed with stirring. Further, the TAG-containing oil or fat was placed in the container, and mixed with these materials with stirring to obtain a mixture (Comparative Example 6-A).

### Comparative Example 6-B

Powdered soy sauce, porosity-imparted starch, and TAG-containing oil or fat to be used in Comparative Example 6-B are the same as those in Example 1-B1. The powdered soy sauce and the porosity-imparted starch were placed in the container, and mixed with stirring. Further, the TAG-containing oil or fat was placed in the container, and mixed with these materials with stirring to obtain a mixture (Comparative Example 6-B).

### Comparative Example 6-C

Powdered soy sauce, puffed corn flour, and TAG-containing oil or fat to be used in Comparative Example 6-C are the same as those in Example 1-C1. The powdered soy sauce and the puffed corn flour were placed in the container, and mixed with stirring. Further, the TAG-containing oil or fat was placed in the container, and mixed with these materials with stirring to obtain a mixture (Comparative Example 6-C).

### Test Example 6

In connection with the mixtures according to the above-described Comparative Examples 6-A to 6-C, the mesh passage rate was calculated in the same manner as in Test Example 1.

The mesh passage rates were 0% in Comparative Examples 6-A and 6-C, and 5% in Comparative Example 6-B. As seen here, the mesh passage rates were less than 50% in all of these Comparative Examples.

The differences between Comparative Examples 6-A to 6-C and Examples 1-A1, 1-B1, 1-C1 in Test Example 1 resided in whether or not granulation took place. This outcome demonstrated that the granular soy sauce prevented from caking was obtained by granulating the mixture.

1. A method for producing granular soy sauce, comprising:
mixing an edible oil, powdered soy sauce, and at least one porous material selected from the group consisting of pregelatinized rice flour, pregelatinized corn meal, and starch which has been rendered porous by enzyme treatment; and
granulating the mixture.

2. The method for producing granular soy sauce according to claim 1, wherein
the edible oil is rice bran oil, or an oil or fat which consists essentially of a triacylglycerol formed by ester linkage of a fatty acid having 6 to 10 carbon atoms and glycerol.

3. The method for producing granular soy sauce according to claim 1, wherein
the granulating is performed by extrusion granulation.

4. Granular soy sauce, comprising:
an edible oil;
powdered soy sauce; and
at least one porous material selected from the group consisting of pregelatinized rice flour, pregelatinized corn meal, and starch which has been rendered porous by enzyme treatment.

5. The method for producing granular soy sauce according to claim 2, wherein
the granulating is performed by extrusion granulation.
